(19) United States
(12) Patent Application Publication
(10) Pub. No.: US 2004/0088414 A1
(43) Pub. Date: May 6, 2004

(54) Reallocation of computing resources

(76) Inventors: Thomas J. Flynn, Magnolia, TX (US); Thomas J. Josefy, Houston, TX (US); Gary A. Willett, Katy, TX (US)

Correspondence Address: HEWLETT-PACKARD COMPANY, Intellectual Property Administration, P.O. Box 272400, Fort Collins, CO, 80527-2400, US

(21) Appl. No.: 10/289,094

(22) Filed: Nov. 6, 2002

(51) Int. Cl. G06F 15/173; G06F 15/16

(52) U.S. Cl. 709/226; 709/201

(57) ABSTRACT

The disclosed embodiments relate to a network computing method and architecture that may employ client computing devices to provide a client computing interface. A computing engine may support the client computing interface and allow allocation of computing power to different functions such as client support or web hosting. Excess computing power may be sold or leased.

### BACKGROUND OF THE RELATED ART

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Since the introduction of the first personal computer (“PC”) over 20 years ago, technological advances to make PCs more useful have continued at an amazing rate. Microprocessors that control PCs have become faster and faster, with operational speeds eclipsing a gigahertz (one billion operations per second) and continuing well beyond.

Productivity has also increased tremendously because of the explosion in the development of software applications. In the early days of the PC, people who could write their own programs were practically the only ones who could make productive use of their computers. Today, there are thousands and thousands of software applications ranging from games to word processors and from voice recognition to web browsers.

a. The Evolution of Networked Computing

In addition to improvements in PC hardware and software generally, the technology for making computers more useful by allowing users to connect PCs together and share resources between them has also seen rapid growth in recent years. This technology is generally referred to as “networking.” In a networked computing environment, PCs belonging to many users are connected together so that they may communicate with each other. In this way, users can share access to each other's files and other resources, such as printers. Networked computing also allows users to share internet connections, resulting in significant cost savings. Networked computing has revolutionized the way in which business is conducted across the world.

Not surprisingly, the evolution of networked computing has presented technologists with some challenging obstacles along the way. One obstacle is connecting computers that use different operating systems (“OSes”) and making them communicate efficiently with each other. Each different OS (or even variations of the same OS from the same company) has its own idiosyncrasies of operation and configuration. The interconnection of computers running different OSes presents significant ongoing issues that make day-to-day management of a computer network challenging.

Another significant challenge presented by the evolution of computer networking is the sheer scope of modern computer networks. At one end of the spectrum, a small business or home network may include a few client computers connected to a common server which may provide a shared printer and/or a shared internet connection. On the other end of the spectrum, a global company's network environment may require interconnection of hundreds or even thousands of computers across large buildings, a campus environment, or even between groups of computers in different cities and countries. Such a configuration would typically include a large number of servers, each connected to numerous client computers.

Further, the arrangements of servers and clients in a larger network environment could be connected in any of a large number of topologies that may include local area networks (“LANs”), wide area networks (“WANs”) and municipal area networks (“MANs”). In these larger networks, a problem with any one server computer (for example, a failed hard drive, corrupted system software, failed network interface card or OS lock-up to name just a few) has the potential to interrupt the work of a large number of workers who depend on network resources to get their jobs done efficiently. Needless to say, companies devote considerable time and effort to keep their networks operating trouble-free to maximize productivity.

b. The Development of Thin Client Computing

Networks are typically populated with servers and client computers. Servers are generally more powerful computers that provide common functions such as file sharing and Internet access to the client computers. Traditionally, client computers have themselves been fully functional computers, each having a processor, hard drive, CD ROM drive, floppy drive, and system memory.

Recently, thin client computing devices have begun to appear. Thin client computing devices are generally capable of only the most basic functionality. Many thin client computers do not have their own hard drives, CD ROM drives, or floppy drives. Thin client computers may typically be connected to a network to boot an operating system or load application programs such as word processors or Internet browsers. Additionally, thin clients may have only a relatively small amount of system memory and may have a relatively slow processor compared to fully functional client computer workstations.

What thin clients lack in computing power, however, they make up for in other areas such as reliability. Thin clients may typically be more reliable than their fully functional counterparts because thin clients typically may have fewer parts. For example, many thin clients do not have their own hard drive. Because the hard drive is one of the most likely computer components to fail, the lack of a hard drive may account for a significant increase in the reliability of a thin client computer compared to a fully functional computer with its own hard drive.

The high reliability of thin clients makes them potentially desirable for use in a networked environment. Network maintenance costs are a significant expense in large network environments and companies and other organizations spend a large amount of resources to reduce those costs. Thin clients have the potential to reduce networking costs because of their relative simplicity and increased reliability with respect to fully functional client computers.

In a typical thin client networked environment, thin clients may be connected to a centralized server. The thin client computer may typically communicate with the server through a multi-user terminal server application program. The centralized server may be responsible for providing an operating system for the thin clients that are connected to it. Additionally, the centralized server may supply application programs such as word processing and Internet browsing to the thin clients as needed. The user's data, such as document files, spreadsheets, and Internet favorites, may be stored on the centralized server as well. Thus, when a thin client breaks, it may be removed and replaced without the need to transfer the user's programs to the replacement unit.

Nonetheless, the lack of computing power of some thin clients may have slowed their acceptance rate among network administrators. This slow acceptance may be partially true because of the methods of distributing computing power from the centralized server to thin client computers utilized. Problems may arise when a user of a thin client connected to a central server through a multi-user terminal server application begins the execution of a process that requires a relatively large amount of computing power. If the centralized server does not unable to distribute the computing load effectively, then other thin client users connected to the centralized server through the terminal server application may experience performance problems because of the portion of the power of the centralized server is being diverted to process the needs of a single user.

c. The Development of Server Blades

Another recent development in the field of network computing is having a growing impact. That development is the server blade. Server blades, such as the Proliant BL e-Class product line available from the assignee of the present application, are ultra-dense, low power server computers that are designed to provide a high level of computing power in a relatively small space. A server blade may include many components of a server on a printed circuit board, which may be referred to as a blade. Examples of components that may be included on a server blade may include a network interfaces, a CPU, system memory and/or a hard disk. These components may be designed for low power consumption. Server blades may be installed by plugging them into an enclosure, such as a cabinet or chassis. It may be possible to include more server blades in the space previously occupied by non-blade servers. In addition, server blades may provide additional computing power while reducing power consumption, cooling requirements and/or cabling complexity. Power and networking connections may be provided by server blade backplanes into which multiple server blades may be plugged.

Because blade servers take up much less space than conventional servers, they may result in significant cost savings compared to conventional servers. Additionally, blade servers may be ganged together to form computing engines of immense power. An effective way to employ server blades and thin clients in a centralized network architecture that efficiently distributes computing power and provides other advantages is desirable.

### BRIEF DESCRIPTION OF THE DRAWINGS

Advantages of the invention may become apparent upon reading the following detailed description and upon reference to the drawings in which:

FIG. 1 is a block diagram of a client-server computer network architecture;

FIG. 2 is a block diagram of an example of a network architecture according to embodiments of the present invention;

FIG. 3 is a block diagram of an example of a network architecture that is useful in explaining the allocation of network resources according to embodiments of the present invention; and

FIG. 4 is a process flow diagram according to embodiments of the present invention.

### DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

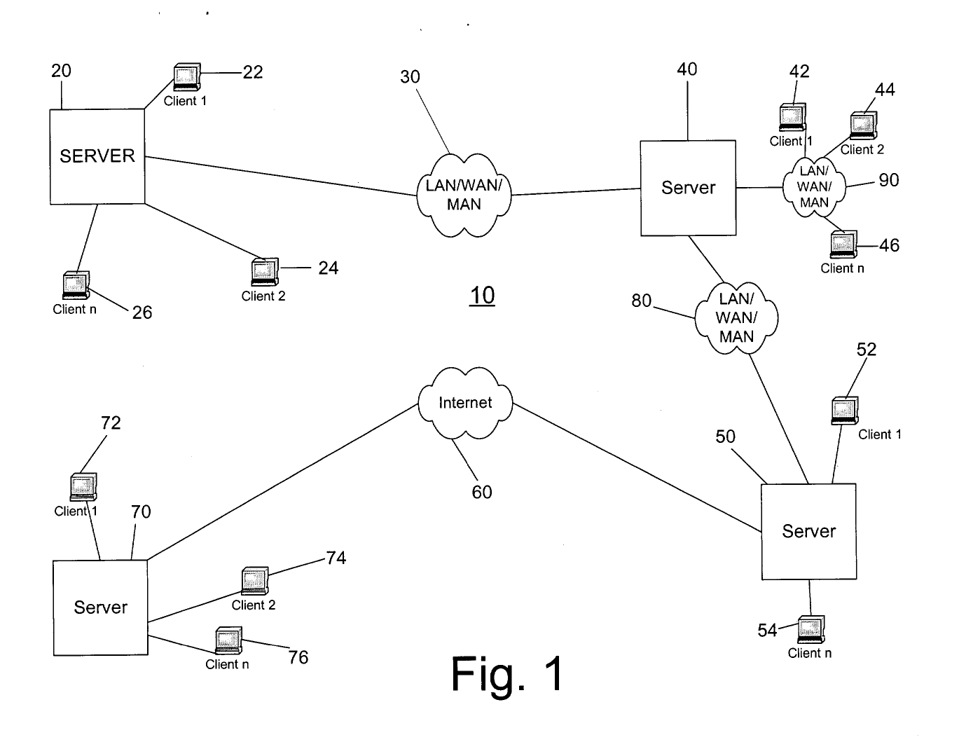

Turning now to the drawings and referring initially to FIG. 1, a block diagram of a computer network architecture is illustrated and designated using a reference numeral 10. A server 20 is connected to a plurality of client computers 22, 24 and 26.

The server 20 may be connected to as many as n different client computers. Each client computer in the network 10 may be a fully functional client computer. The magnitude of n may be a function of the computing power of the server 20. If the server 20 has large computing power (for example, faster processor(s) and/or more system memory), it may be able to effectively serve a large number of client computers.

The server 20 is connected via a network infrastructure 30, which may include any combination of hubs, switches, routers, and the like. While the network infrastructure 30 is illustrated as being either a local area network (“LAN”), a wide area network (“WAN”) or a municipal area network (“MAN”), those skilled in the art will appreciate that the network infrastructure 30 may assume other forms or may even provide network connectivity through the Internet. As will be described, the network 10 may include other servers, which may be widely dispersed geographically with respect to the server 20 and to each other to support client computers in other locations.

The network infrastructure 30 connects the server 20 to server 40, which may be representative of any other server in the network environment of server 20. The server 40 may be connected to a plurality of client computers 42, 44, and 46. As illustrated in FIG. 1, a network infrastructure 90, which may include a LAN, a WAN, a MAN or other network configuration, may be used to connect the client computers 42, 44 and 46 to the server 40. The server 40 is additionally connected to server 50, which is in turn connected to client computers 52 and 54. A network infrastructure 800, which may include a LAN, a WAN, a MAN or other network configuration, may be used to connect the client computers 52, 54 to the server 50. The number of client computers connected to the servers 40 and 50 may be dependent on the computing power of the servers 40 and 50, respectively.

The server 50 may additionally be connected to the Internet 60, which may in turn be connected to a server 70. The server 70 may be connected to a plurality of client computers 72, 74 and 76. The server 70 may be connected to as many client computers as its computing power will allow.

Those of ordinary skill in the art will appreciate that the servers 20, 40, 50, and 70 may not centrally located. A network architecture, such as the network architecture 10, may typically result in a wide geographic distribution of computing resources that must be maintained. The servers 20, 40, 50, and 70 must be maintained separately. Also, the client computers illustrated in the network 10 are subject to maintenance because each may itself be a fully functional computer that stores software and configuration settings on a hard drive or elsewhere in memory. In addition, many of the client computers connected with the network 10 may have their own CD-ROM and floppy drives, which may be used to load additional software. The software stored on the fully functional clients in the network 10 may be subject to damage or misconfiguration by users. Additionally, the software loaded by users of the client computers may itself need to be maintained and upgraded from time to time.

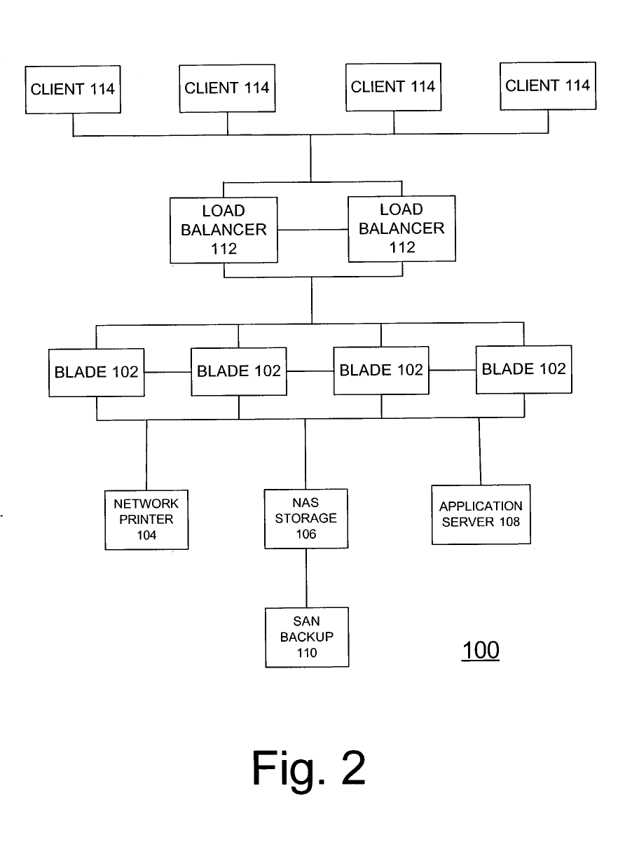

FIG. 2 is a block diagram of an example of a network architecture in accordance with embodiments of the invention. The network architecture is referred to generally by the reference numeral 100.

A plurality of server blades 102 are connected together to form a centralized computing engine. Four server blades are shown in the network architecture 100 for purposes of illustration, but server blades may be added to or removed from the computing engine as needed. The server blades 102 may be connected by a network infrastructure so that they may share information. PCI-X, Infiniband or any other suitable network infrastructure may be examples of network infrastructures that may be employed to interconnect the server blades 102 together.

The server blades 102 may be connected to additional computing resources, such as a network printer 104, a network attached storage (“NAS”) device 106, and/or an application server 108. NAS devices, such as the NAS device 106, may be specialized file serving devices that provide support for heterogeneous files in a high capacity package. NAS may also provide specific features to simplify the tasks and reduce the resources associated with data storage and management. A NAS solution may work with a mix of clients and servers running different operating systems.

The NAS device 106 may be connected to a back-up device such as a storage attached network (“SAN”) back-up device 110. A SAN may be a storage architecture in which storage devices may be connected together on an independent network with respect to servers and client computers. SANs may be used to provide back-up capability in a NAS storage environment.

The server blades 102 may additionally be connected to a plurality of load balancers 112. For purposes of illustration, two load balancers 112 are shown. Additional load balancers may be added to facilitate handling of larger amounts of network traffic or other reasons. The load balancers 112 may comprise load balancing switches or routers, or any other device that may distribute the computing load of the network among the plurality of server blades 102. The load balancers 112 may be connected to a plurality of client computers 114 and are adapted to receive network traffic, including requests to perform computing services, such as to perform computing tasks or store or print data. While four client computers are illustrated, a lesser or greater number may be employed.

The load balancers 112 may distribute requests among the server blades 102 according to any protocol or scheme. Examples of distribution schemes that may be used are round-robin distribution or use-based distribution schemes. In a round-robin distribution scheme, no consideration is taken for whether the server blade requested to perform a task is under-utilized or over-utilized. Instead, requests are simply passed to the server blades in a predetermined. In a use-based distribution scheme, the load balancers 112 may have the capability to communicate with the server blades 102 to determine the relative workload being performed by each of the server blades 102. Requests for additional work may be forwarded to a server blade that may service the request.

The client computers 114 may comprise thin client computer systems. The load balancers 112 may be connected to the client computers through a single-user terminal server program such as the single-user terminal server utility that is provided as part of the Microsoft Windows XP operating system, which is available from Microsoft Corporation of Redmond, Wash. Other single-user terminal server applications may be used, as well.

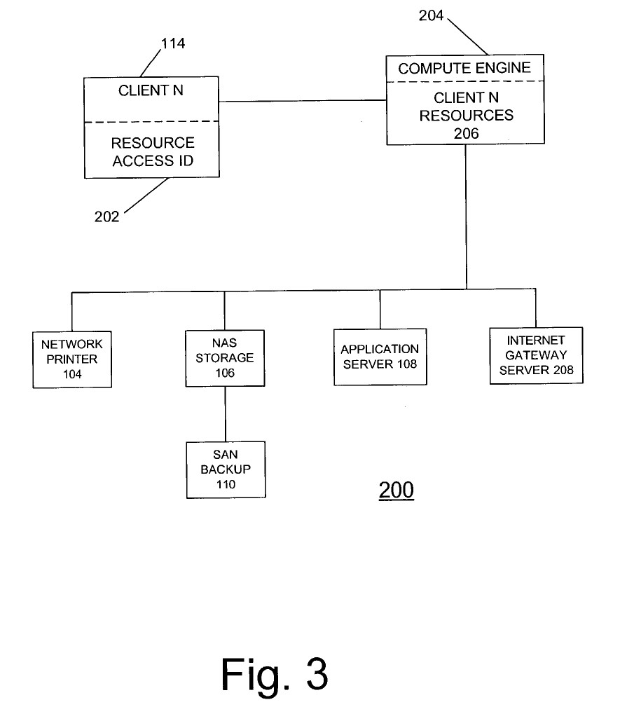

FIG. 3 is a block diagram of an example of a network architecture that is useful in explaining the allocation of network resources according to embodiments of the present invention. A network configuration generally referred to by the reference numeral 200 is shown. The network configuration 200 is generally similar to the network configuration 100 (FIG. 2), except that the server blades shown in the network configuration 100 have been divided into two computing engines 103 and 105 in the network configuration 200.

Each of the computing engines 103 and 105 may be adapted to support a different function in the network architecture 200. The first computing engine 103, which may be adapted to provide network data resources to the client computers 114 that may be thin clients, may be coupled to the network printer 104, the network attached storage device 106, and the application server 108. The second computing engine 105 may be adapted to perform other functions such as to provide connectivity to the Internet 116 to users of the client computers 114. The computing engine 105 may additionally be adapted to function as a web server to provide web-based content to external users 118 via the Internet 116. The load balancers 112 may be configured to send requests for different types of resources (e.g. data management computing resources or Internet access computing resources) to the computing engine that provides that functionality.

Each of the computing engines 103 and 105 may be comprised of one or more server blades or other computing resource capable of providing computing power. The number of server blades used for each of the computing engines 103 and 105 may depend on the computing power required by the function being performed by the specific computing engine. Server blades may be added to, removed from, or switched (physically or electronically) between the computing engine 103 and the computing engine 105 depending on the functions being performed by the network architecture 200 at a given time or other reasons. In this manner, the network architecture 200 may facilitate the easy reallocation of computing resources depending on the needs of the network.

If additional client computers 114 are added to the network architecture 200, additional server blades may be added to the computing engine 103 to support the work being done by users of the client computers 114. If the computing engine 105 is under-utilized, server blades may be removed from the computing engine 105 and installed in the computing engine 103 to facilitate service of the client computers 114.

Also, additional server blades may be added to the computing engine 105 as needed or advantageous. Additional computing power may be needed for the computing engine 105 if the web hosting function that may be provided by the computing engine 105 is over-utilized. Examples of situations that could create a need for additional web hosting computing power include, for example, popular growth of the web presence supported by the computing engine 105 or high seasonal demand for the content that is hosted (e.g. holiday shopping season or tax preparation season). To bolster the computing power of the computing engine 105, additional server blades may be purchased and added to the computing engine 105. Alternatively, server blades may be removed from the computing engine 103 and added to the computing engine 105. If the period of high demand for the computing resources provided by the computing engine 105 subsides, the server blades moved to the computing engine 105 to support the increased demand may be returned to the computing engine 103.

During periods of time when the total computing power provided by both computing engines 103 and 105 is under utilized, the excess computing power may be sold or leased to users desiring the excess computing power. An example of one strategy for selling or leasing excess computing power may be to install all available server blades as part of the computing engine 105 and make that computing power available for sale or lease to users 115 via the Internet 113.

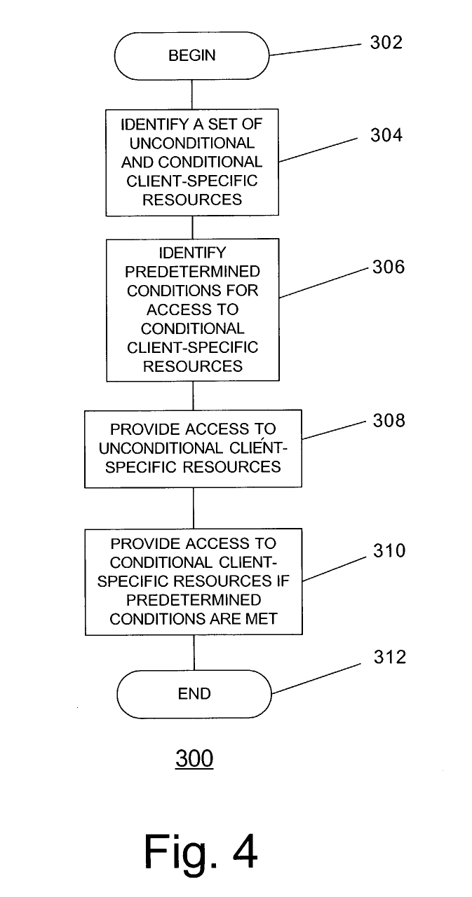

FIG. 4 is a process flow diagram in accordance with embodiments of the invention. The process is generally referred to by the reference numeral 300. At block 302, the process begins. At block 304, a plurality of computing engines is provided. The computing engines may correspond to different functions that need to be provided in a given network environment. For example, one computing engine may have the function of supporting the computing requirements of a plurality of client computers. The computing engine 103 (FIG. 2) is an example of this type of computing engine. As another example, one computing engine may serve the function of providing connectivity to the Internet for users of the network and/or for web hosting. The computing engine 105 (FIG. 3) is an example of this type of computing engine.

At block 306, the computing power may be allocated among the computing engines based on the needs of the network at a given time. One example of a way to reallocate the resources of the computing engines is to construct the computing engines using server blades, such as the server blades 102 (FIG. 2). Server blades may be readily moved from computing engines that are dedicated to performing a function that is underutilized to a computing engine that supports a function that is overutilized. Also, additional server blades may be purchased and added to a computing engine if the function supported by that computing engine is growing in utilization and server blades are not available from another computing engine within the network.

Additional computing power may be sold or leased if it is not needed at a specific time. An example of a situation that may lend itself to selling or leasing additional computing capacity is if a given network is subject to a seasonal high period of activity that then declines. Examples of such seasonal activity may be a holiday selling season or a tax preparation season. When the period of increased activity has passed, additional computing power that is needed during the period of increased activity may be sold or leased to offset a portion of the expense of the computing resources. One example of a scenario for disposing of excess computing power may be to configure a computing engine with the additional computing power and make the computing power available for sale or lease over the Internet.

At block 308, requests for computing services are processed by the computing engines. At block 310, the process ends.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A computer network, comprising:
a plurality of computing engines, each of the computing engines having a function associated therewith, each of the computing engines comprising at least one computing resource that may be allocated between or among the plurality of computing engines;
a plurality of client computers; and
a load balancer that is adapted to receive requests for computing services from the plurality of client computers and to direct the requests for computing services to one of the plurality of computing engines.

2. The computer network of claim 1, wherein the at least one computing resource is a server blade.

3. The computer network of claim 1, wherein the at least one computing resource is a server blade that may be disconnected from one of the plurality of computing engines and connected to another of the plurality of computing engines.

4. The computer network of claim 1, wherein the load balancer directs a request for computing services to one of the plurality of computing engines having a predetermined function that corresponds to the request for computing services.

5. The computer network of claim 1, wherein the client computers comprise thin client computing devices.

6. The computer network of claim 5, wherein the thin client computing devices are each connected to the load balancer by a single-user terminal server application.

7. A computing engine, comprising:
at least one computing resource that may be removed and allocated to another computing engine; and
wherein the computing engine is adapted to receive requests from a load balancer that is adapted to provide requests of a specific type to the computing engine.

8. The computing engine of claim 7 wherein the at least one computing resource is a server blade.

9. The computing engine of claim 7 wherein the computing engine has a specific function and the load balancer is adapted to direct a request for computing services to the computing engine based on the ability of the computing engine to perform the specific function.

10. A method of operating a computer network, the method comprising:
providing a plurality of computing engines, each of the plurality of computing engines comprising at least one computing resource, each of the computing engines being adapted to process requests for computing services of a specific type;
allocating the computing resources between or among the plurality of computing engines based on demand for computing services of at least one of the specific types; and
processing requests for computing resources using the computing engines.

11. The method of claim 10 comprising selling computing power of the plurality of computing engines.

12. The method of claim 10 comprising selling computing power of the plurality of computing engines that is not needed by the computer network.

13. The method of claim 10 comprising leasing computing power of the plurality of computing engines.

14. The method of claim 10, wherein one of the plurality of computing engines is adapted to process requests for data management computing services and another of the plurality of computing engines is adapted to process requests for other computing services.

15. The method of claim 10 comprising leasing computing power of the plurality of computing engines that is not needed by the computer network.

16. The method of claim 10 comprising load balancing the requests for computing services.

17. The method of claim 10, wherein the at least one computing resource is a server blade.

18. The method of claim 10, wherein the at least one computing resource is a server blade that may be disconnected from one of the plurality of computing engines and connected to another of the plurality of computing engines.

19. The method of claim 10 comprising directing a request for computing services to one of the plurality of computing engines based on the specific type of request for computing services associated with that computing engine.

20. The method of claim 10, wherein the recited acts are performed in the recited order.

21. A computer network, comprising:
a plurality of means for computing, each having at least one computing resource, each of the plurality of means for computing being adapted to process requests for computing services of a specific type; and
means for allocating the computing resources between or among the plurality of means for computing based on demand for computing services of at least one of the specific types.

22. The computer network of claim 21, wherein each of the plurality of means for computing comprises at least one server blade.

23. The computer network of claim 21, wherein the means for allocating computing resources comprises a load balancer.

24. The computer network of claim 21, wherein the at least one computing resource is a server blade that may be disconnected from one of the plurality of means for computing and connected to another of the plurality of means for computing.

25. The computer network of claim 21, wherein requests for computing services is directed to one of the plurality of means for computing based on the specific type of request for computing power associated with that means for computing.

26. A computer network, comprising:
a plurality of client computers, each of the client computers being adapted to generate requests for computing services of different types;
a load balancer for receiving the requests for computing services from the client computers and distributing the requests according to a specific criteria based on the type of request; and
a plurality of server blades adapted to be deployed as at least two computing engines, each of the computing engines being adapted to process requests for computing services of at least one particular type, the computing engines receiving requests for computing services distributed by the load balancer.

27. The computer network of claim 26, wherein the server blades are adapted to be moved from one of the at least two computing engines and deployed in another of the at least two computing engines.

28. The computer network of claim 26, wherein the client computers comprise thin client computing devices.

29. The computer network of claim 28, wherein the thin client computing devices are each connected to the load balancer by a single-user terminal server application.
